(19) United States
(12) Patent Application Publication
(10) Pub. No.: US 2008/0151833 A1
(43) Pub. Date: Jun. 26, 2008

(54) METHOD AND APPARATUS FOR DISTRIBUTED BANDWIDTH ASSIGNMENT IN MESH BACKHAUL NETWORKS

(75) Inventor: Kadathur S. Natarajan, Wilmette, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/613,457

(22) Filed: Dec. 20, 2006

(51) Int. Cl. H04Q 7/00

(52) U.S. Cl. 370/331

(57) ABSTRACT

A system for distributing bandwidth in a mesh network includes a first access point (AP1) that determines an amount of data to be sent from the first access point to the second access point (AP2) and receives a value indicating an amount of data to be received from the second access point. The first access point (AP1) then determines a percentage of a frame (I) to be used to send the data from the first access point to the second access point by multiplying the total data-carrying portion (206, 210) of the frame (I) by the amount of data to be sent from the first access point to the second access point divided by the sum of the amount of data to be sent from the first access point to the second access point and the amount of data to be received from the second access point.

### FIELD OF THE INVENTION

This invention relates in general to communication systems, and more specifically to a system, method, and apparatus for dynamically distributing bandwidth within a wireless mesh communications network.

### BACKGROUND OF THE INVENTION

The traditional approach used for terrestrial wireless communication networks such as cellular networks consists of dividing the desired coverage area into a set of overlapping regions, where all of the subscribers within each region are served from a single transceiver known as an “access point.” Each access point provides a direct connection to one or more other access points, serves a transit routing function by routing traffic to and from a core network, and provides shared access to subscribers for both uplink and downlink communications. This type of network is generally referred to as a “mesh” network.

In a mesh architecture 100 such as depicted in FIG. 1 a plurality of access points, AP1-AP6 are deployed and operate in a peer-to-peer fashion to establish links, where possible, and as required, among each access point's neighbors. For example unit AP3 can establish links or paths 102, 104, and 106 with, respectively, units AP4, AP6, and AP2.

Each or several of the access points AP1-AP6 have the ability to relay communications signals from an originating access point to a target access point when these access points are not able to create a direct communication link or path from one to the other point. Information that is being communicated may be relayed or handed from access point to access point until it reaches the intended destination or target access point. For example, if access point AP4 wanted to communicate with access point AP2 or the core network, information from access point AP4 would be relayed by access point AP6 to access point AP2 or on to the core network. However, if the direct link from access point AP4 to AP6 was interrupted or blocked, the inherent redundancy in the mesh architecture allows routing the information from access point AP4 through access point AP5 or access point AP3.

The mesh architecture or system can experience temporary congestion problems as the density of the communication traffic increases. One known way to deal with this problem is to provision the links with sufficient capacity for handling the worst-case traffic congestion conditions. However, this is an expensive solution. Another way to deal with the problem is to provision the links with sufficient capacity for average load conditions, and devise methods for dynamically sharing the backhaul links in a way so that traffic is balanced across the backhaul links even under heavy traffic conditions.

Table 1 shows a portion of an exemplary routing table for access point AP4 in the mesh network 100 shown in FIG. 2.

TABLE 1
Routing Table at AP4 (partial routing table)

| Destination | Next Access Point | Percentage of Traffic |
|---|---|---|
| AP5 | AP5 | 100% |
| AP2 | AP3 | 30% |
| AP2 | AP6 | 70% |

The first column of Table 1 is the destination access point for traffic flowing from access point AP4. The destination access point is the final destination of traffic being sent from AP4 regardless of the path it takes within the mesh network 100. After the data reaches the final destination, it is forwarded on to the core network.

The second column in Table 1 is the next access point, which specifies the next step in the path taken to reach the destination specified in column 1. In larger networks, Table 1 would be expanded to include many additional rows to identify various path choices for the data to reach the various destinations. The third column identifies the percentage of traffic that will be routed by Access Point AP4 in the next step toward the destination (indicated in column 1) along the next access point (indicated in column 2). Specifically, looking at Table 1, for the final destination AP2, access point AP4 can route traffic packets through AP3 or AP6 as the next access point. If it goes through AP6, access point AP4 would route 70% of the traffic packets to AP6. If it goes through AP3, access point AP4 would route 30% of the traffic packets to AP3.

Table 2 shows an exemplary partial routing table for access point AP3 in the mesh network 100 shown in FIG. 2

TABLE 2
Routing Table at AP3 (partial routing table)

| Destination | Next Access Point | Percentage of Traffic |
|---|---|---|
| AP2 | AP2 | 100% |
| AP5 | AP4 | 50% |
| AP5 | AP6 | 50% |

The percentage of traffic is varied on a frame-by-frame basis to adjust to the instantaneous fluctuation in the amount of backhaul traffic that must be transported between neighboring access points. If the percentage of traffic is kept fixed along each backhaul link, temporary congestions will result in loss of packets or otherwise degrade the quality of service for end user applications (resident on devices 200 or on server devices attached to the core network (not shown in figure)).

Therefore a need exists to overcome the problems with the prior art as discussed above.

### SUMMARY OF THE INVENTION

Embodiments of the present invention provide a method and a device in a wireless communication system providing at least one time division duplexing communication channel for communicating data between a first and a second access point. In a first embodiment of the invention, the method determines an amount of data to be sent from a first access point to a second access point; receives a value indicating an amount of data to be received from the second access point; and determines a percentage of a frame to be used to send the data from the first access point to the second access point by multiplying the total data-carrying portion of the frame by the amount of data to be sent from the first access point to the second access point divided by the sum of the amount of data to be sent from the first access point to the second access point and the amount of data to be received from the second access point.

A second embodiment of the present invention provides a first access point in a wireless communication system. The first access point provides at least one time division duplexing communication channel for communicating data between the first access point and a second access point. The first access point comprises a data counter for determining an amount of data to be sent to the second access point; an input for receiving a value indicating an amount of data to be received from the second access point; and a processor for determining a percentage of a frame to be used to send the data from the first access point to the second access point by multiplying the total data-carrying portion of the frame by the amount of data to be sent from the first access point to the second access point divided by the sum of the amount of data to be sent from the first access point to the second access point and the amount of data to be received from the second access point.

An advantage of the foregoing embodiments of the present invention is that dynamic optimization of available resources is provided to wireless communication devices. Information can be more efficiently communicated between subscriber devices and a core network by optimizing uplink and downlink time distribution within backhaul frames. The present invention, according to one embodiment, reduces unused frame portions and maximizes frame data-carrying capacity.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating an exemplary mesh network communications system;

FIG. 2 is a block diagram illustrating a communication system that includes the mesh network of FIG. 1 in wireless communication with subscriber devices, according to an embodiment of the present invention;

FIG. 3 is a block diagram illustrating an exemplary access point, according to an embodiment of the present invention;

FIG. 4 illustrates a frame structure for time division duplex communications where subsequent frames have been shifted to distribute bandwidth according to an embodiment of the present invention; and

FIG. 5 is an operational flow diagram of a bandwidth distribution process according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Exemplary Wireless Communications System

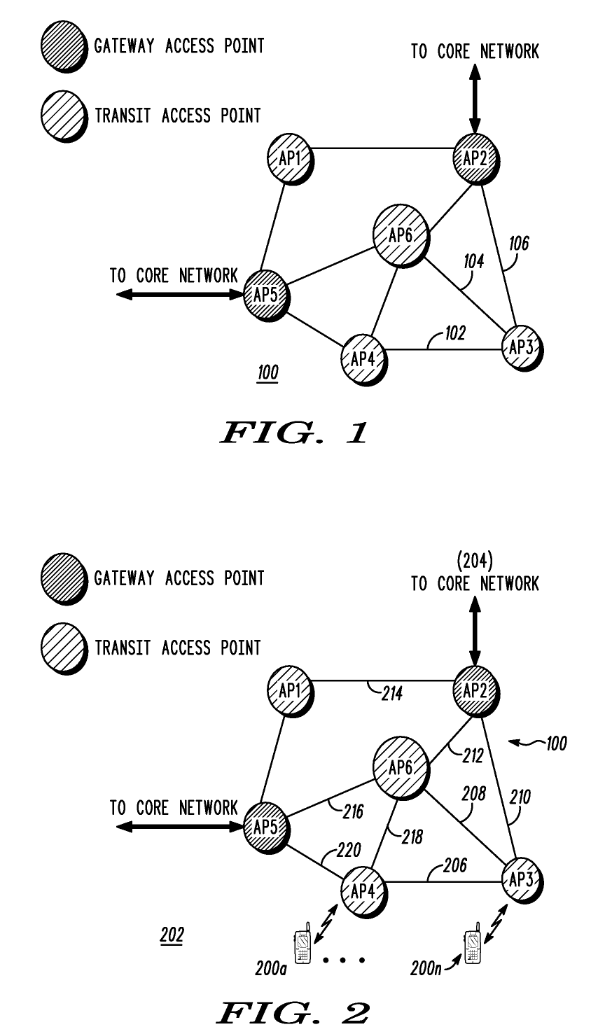

According to an embodiment of the present invention, as shown in FIG. 2, exemplary wireless communication devices 200a-n are illustrated communicatively coupled to a mesh network 100. The wireless communications network 100 connects wireless communication devices 200a-n to a core network 204. The wireless mesh communications network 100 comprises a mobile phone network, a mobile text messaging device network, a pager network, or the like. Furthermore, the communications standard of the mesh communications network 100 of FIGS. 1 and 2 comprises Code Division Multiple Access (CDMA), Time Division Multiple Access (TDMA), Global System for Mobile Communications (GSM), General Packet Radio Service (GPRS), Frequency Division Multiple Access (FDMA), Orthogonal Frequency Division Multiplexing (OFDM), WiMax 802.16e or the like. Additionally, the wireless communications network 100 comprises text messaging standards, for example, Short Message Service (SMS), Enhanced Messaging Service (EMS), Multimedia Messaging Service (MMS), or the like; and allows for push-to-talk over cellular communications between capable wireless communication devices.

The wireless network 100 supports any number of wireless communication devices 200a-n. The support of the wireless network 100 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities. In one embodiment, wireless communications network 100 allows for mesh networking between two or more wireless communication devices 200a-n.

In an exemplary embodiment, the mesh communications network 100 is capable of broadband wireless communications utilizing time division duplexing (“TDD”). The TDD duplexing scheme allows for bidirectional transmission of signals using a single frequency. TDD is flexible with regard to allocation of timeslots for forward and reverse, making it well suited for asymmetrical applications. It should be noted that the present invention is not limited to an 802.16e system for implementing TDD. Other standards are also applicable.

The mesh communication network 100, the core network 204, and the wireless communication devices 200a-n together comprise a wireless communication system 202. The wireless communications system 202 is not limited to a system using only a TDD scheme. For example, TDD may be used for only a portion of the available communication channels in the communication system, while one or more schemes are used for the remaining communication channels.

Access Points

The mesh network 100 includes a group of base stations, or “access points” AP1-AP6 that each has a dedicated connection to a subset of other access points AP1-AP6. Each access point AP1-AP6 provides shared access to subscriber devices 200a-n (both Uplink, i.e., from the devices 200a-n to the core network 204, and Downlink, i.e., from the core network 204 to the devices 200a-n). The access points AP1-AP6 are connected in a mesh network topology to route the traffic to/from the core network 204. A “Gateway” access point is an access point that serves dual purposes: 1. the standard function of providing access to subscribers it covers; and 2. to serve as ingress and egress points to the core network 204. A “Transit” access point is an access point that: 1. provides access service to subscribers in its coverage area; and 2. serves as a transit node for forwarding traffic to subscribers that are served by other access points.

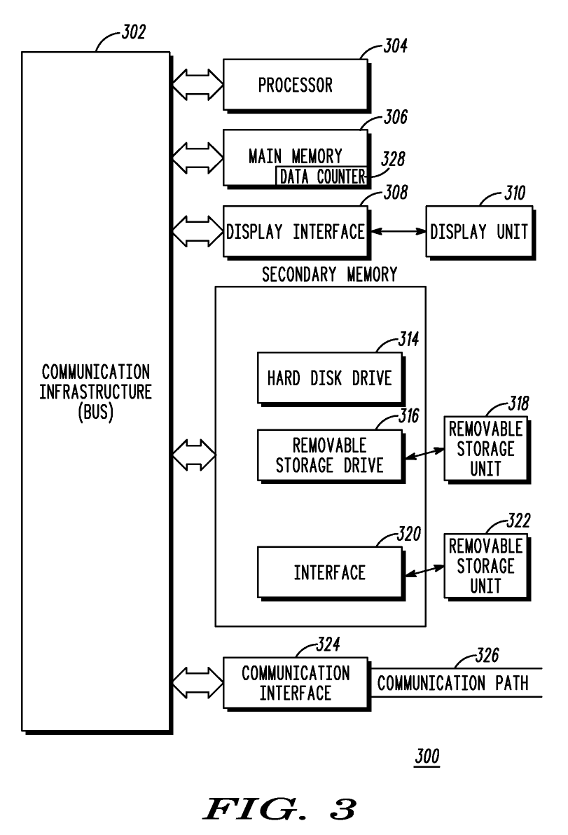

FIG. 3 is a high level block diagram illustrating a more detailed view of a processing and communication system utilized with the access points AP1-AP6 according to embodiments of the present invention. FIG. 3 shows an information processing system 300 useful for implementing one of the access points AP1-AP6. The system 300, in one embodiment, resides outside of and is communicatively coupled to its respective access point. In another embodiment, the system 300 resides within its respective access point. The information processing system 300 is based upon a suitably configured processing system adapted to implement the exemplary embodiment of the present invention. For example, a personal computer, workstation, or the like, may be used.

In one embodiment of the present invention, the computer system 300 includes one or more processors, such as processor 304. The processor 304 is connected to a communication infrastructure 302 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system 300 can include a display interface 308 that forwards graphics, text, and other data from the communication infrastructure 302 (or from a frame buffer) for display on the display unit 310. The computer system also includes a main memory 306, preferably random access memory (RAM), and may also include a secondary memory 312 having components such as a hard disk drive 314 and/or a removable storage drive 316 representing a floppy disk drive, a magnetic tape drive, an optical disk drive, etc. The removable storage drive 316 reads from and/or writes to a removable storage unit 318 in a manner well known to those having ordinary skill in the art. Removable storage unit 318, represents a floppy disk, a compact disc, magnetic tape, optical disk, etc. which is read by and written to by removable storage drive 316. As will be appreciated by one of ordinary skill in the art, the removable storage unit 318 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 312 may include other similar means for allowing computer programs or other instructions to be loaded into the computer system as commonly known in the art. Such means may include, for example, a removable storage unit 322 and an interface 320. Examples of such may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to the computer system.

The computer system, in this example, includes a communications interface 324 that allows software and data to be transferred between the computer system and external devices or access points via a communications path 326. Examples of communications interface 324 may include a modem, a network interface (such as an Ethernet card), a communications port, a PCMCIA slot and card, etc. Software and data transferred via communications interface 324 are in the form of signals which may be, for example, electronic, electromagnetic, optical, or other signals capable of being received by communications interface 324. The signals are provided to communications interface 324 via a communications path (i.e., channel) 326. The channel 326 carries signals and may be implemented using wire or cable, fiber optics, a phone line, a cellular phone link, an RF link, and/or other communications channels. Data stored in any of the data storage areas 306, 312 of the computer system 300 can be inventoried. The communication interface 324 also acts as an input for receiving information from other access points, such as values indicating amounts of data that are scheduled to be received from the other access points and as an output for sending data to the other access points. The processor 304 in conjunction with the memory 306, 312 and/or the communication interface 324 performs as a data counter 328 for determining an amount of data to be sent from one access point to another.

In this document, the terms “computer program medium,” “computer usable medium,” and “computer readable medium” are used to generally refer to media such as main memory 306 and secondary memory 312, removable storage drive 316, a hard disk installed in hard disk drive 314, and signals. The computer program products are means for providing software to the computer system. The computer readable medium allows the computer system to read data, instructions, messages or message packets, and other computer readable information from the computer readable medium.

Computer programs (also called computer control logic) are stored in main memory 306 and/or secondary memory 312. Computer programs may also be received via communications interface 324. Such computer programs, when executed, enable the computer system to perform the features of the present invention as discussed herein. In particular, the computer programs, when executed, enable the processor 304 to perform the features of the computer system. Accordingly, such computer programs represent controllers of the computer system.

Mesh Routes

Routes 206-220, shown in FIG. 2, are dedicated communication channels for transporting traffic between each Transit access point and every other access point (Gateway access point as well as Transit access point). The routes can be wired or wireless and can include any medium for transferring data from a first point to a second point. The number of access points and corresponding routes shown in the figures is merely exemplary. The present invention is not limited to any particular number of access points or routes.

Backhauling

Manufacturers of network switching equipment use the term “back hauling” to mean “getting data to the network backbone” or core network. For example, looking again at FIG. 2, the term can be used to describe how an access point AP1-AP6 can be used to interconnect data from a remote user 200 to an Internet service provider and the core network 204.

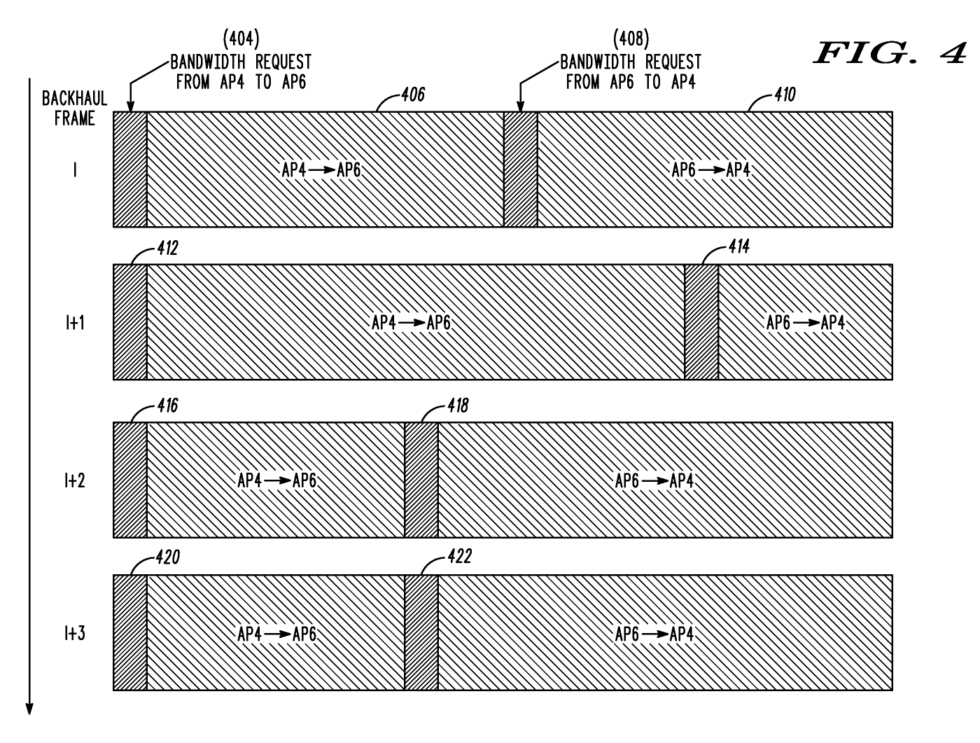

FIG. 4 shows a backhaul frame I for routing data from a first access point AP4 to and from a second access point AP6. The backhaul frame I is divided into four portions. The first portion 404 and the third portion 408 are bandwidth requests and will be discussed in detail below. The second portion 406 is information sent from the first access point AP4 to the second access point AP6 and the fourth portion 410 is information sent from the second access point AP6 back to the first access point AP4. The particular first and second access points used here are merely exemplary and the present invention is not limited to any particular first and second access point.

While in operation, the quantity of data traffic being routed between any two access points within the mesh network 100 changes from moment to moment. In embodiments of the present invention, each access point AP1-AP6, through use of communication interface 324, processor 304, or other means, is able to access the amount of data it has to transmit along each path. Additionally, each access point AP1-AP6 is able to receive and interpret messages, through use of communication interface 324, processor 304, or other means, from other access points indicating an amount of data that those other access points AP1-AP6 have to transmit to that access point. In embodiments of the present invention, this bandwidth information is stored at each access point and communicated in the first 404 and third portions 408 of the backhaul frame I.

Therefore, the first portion 404 of the backhaul frame I is a bandwidth request message identifying the amount of uplink traffic to be transported from Access Point AP4 to Access Point AP6. Bandwidth requests are utilized to compute the fraction of the Backhaul bandwidth that should be used in each direction of the subsequent backhaul frame, identified as I+1 where I is the current frame. Backhaul traffic is determined at the beginning of each backhaul frame based on a number of factors. Exemplary factors may include the amount of uplink traffic to be transported to a Gateway access point, the routes defined at the access point to reach the Gateway access points, the amount of downlink traffic from Gateway access points toward subscribers, the routes defined at each access point to reach other access points, and others.

In accordance with embodiments of the present invention, bandwidth allocation at the beginning of each Backhaul Frame is determined by dividing each backhaul frame of duration T into N time slots. The number of time slots requested by access point L to its neighbor access point M is X. The number of time slots requested by access point M to its neighbor access point L is Y.

A distributed process according to embodiments of the present invention is defined as follows. Access point L will determine a fraction X/(X+Y) of the backhaul frame for transmitting in the direction of access point L to access point M. Conversely, access point M will determine fraction Y/(X+Y) of the backhaul frame for transmitting in the direction of access point M to access point L.

The process can be executed at each access point autonomously utilizing backhaul bandwidth request messages received from the neighboring access points in the mesh network. The Routing Tables used may be changed dynamically based on load conditions or link status changes (such as failures) and the backhaul bandwidth assignment will adjust automatically to the new settings.

For example, assume that each backhaul frame of FIG. 4 is divided into 10 equal slots (N=10) plus two bandwidth request portions. Now suppose that in frame I, bandwidth request 404 from AP4 to AP6 included information that on the subsequent frame I+1, AP4 needs 16 slots to transfer all of its data to access point AP6 and the bandwidth request 408, which includes traffic information from AP6 to AP4, indicated that access point AP6 needs 4 slots of the subsequent backhaul frame I+1 to transfer all of its data to access point AP4. Using an embodiment of the invention, access point AP4 will be allotted 16/(4+16), or 80%, of the next frame and access point AP6 will be allotted 4/(16+4), or 20%, of the next frame. As a result, the next backhaul frame I+1 will have the bandwidth distribution shown in FIG. 4. In backhaul frame I+1, 80% of the total available bandwidth, or 8 slots (N×0.8), is used to send data from access point AP4 to access point AP6. Accordingly, the remaining 20% of the total available bandwidth, or 2 slots (N×0.2), is used to send data from access point AP6 to access point AP4. The “total available bandwidth” is the entire backhaul frame less the two bandwidth request portions. After backhaul frame I+1 is sent, access point AP4 will still have 8 of its original 16 slots of data to send to access point AP6 and access point AP6 will still have 2 of its original 4 slots of data to send to access point AP4. Therefore, one embodiment of the present invention will allow each access point to send half of its total data. More generally, an access point may send a fraction of the traffic to its neighboring access point.

One advantage of the present invention is that it is dynamically adjustable based on the mesh traffic at the beginning of each frame. For instance, if after backhaul frame I is sent, but before backhaul frame I+1 is sent, the mesh traffic has changed, so that now access point AP6 receives 17 slots worth of new data, the allocations would be as follows for the next backhaul frame: access point AP4 will be allocated 8/(8+19), or 30% of the subsequent total frame and access point AP6 will be allocated 19/(8+19), or 70% of the subsequent total frame. As a result, in the backhaul frame I+1 of FIG. 4, the bandwidth request 412 from AP4 to AP6 will include information that on the subsequent frame I+2, AP4 needs 3 slots (equivalent to 30% of the backhaul frame bandwidth). Similarly, the bandwidth request 414, which includes request information from AP6 to AP4, will indicate that AP6 needs 7 slots (equivalent to 70% of the bandwidth of the subsequent backhaul frame I+2). The next backhaul frame will have the bandwidth distributions of backhaul frame I+2 shown in FIG. 4. Note that the access points communicate their bandwidth needs to their neighboring access points in terms of slots needed. The actual determination of backhaul slots allocated in each direction is done locally based on the request information that is exchanged in the previous frame.

The new bandwidth request information will be included in the bandwidth requests 416 and 418 of backhaul frame I+2 of FIG. 4. If no additional traffic is received by either access point AP4 or AP6, the bandwidth request 416 from AP4 to AP6 will include information that on the subsequent frame I+3, AP4 needs 5 slots (equivalent to 5/(5+12) or 30% of the backhaul frame bandwidth), and the bandwidth request 418, which includes traffic information from AP6 to AP4, will indicate a need for 12 slots for AP6 (equivalent to 12/(5+12) or 70% of the backhaul frame bandwidth) of the subsequent backhaul frame I+3. The next backhaul frame will have the bandwidth distributions of backhaul frame I+3 shown in FIG. 4. In backhaul frame I+3, 30% of the total available bandwidth is used to send data from access point AP4 to access point AP6. Accordingly, the remaining 70% of the total available bandwidth is used to send data from access point AP6 to access point AP4. The process will continue until no further data is to be sent.

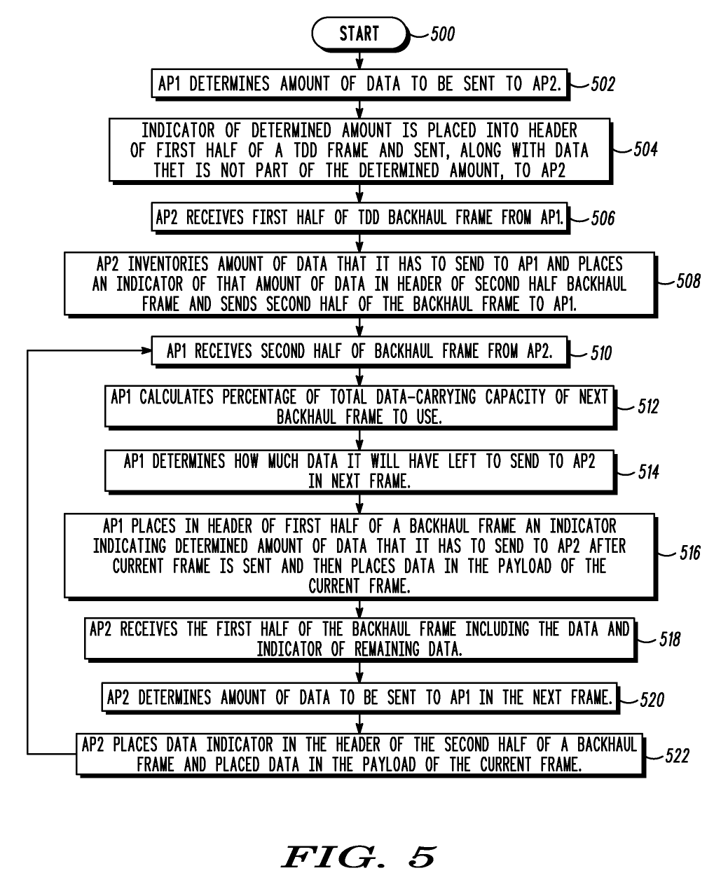

FIG. 5 is illustrates the process flow of the present invention. The process begins at step 500 and flows directly to step 502 where a first access point determines the amount of data it has to send to a second node. In step 504, an indicator of the determined amount is placed into the header of the first half of a TDD backhaul frame and sent, along with data that is not part of the determined amount, to the second access point. In step 506, the second access point receives the first half of the TDD backhaul frame from the first access point. In step 508, the second access point inventories the amount of data it has to send to the first access point, places an indicator of the amount in the header of the second half of the backhaul frame and sends the second half of the backhaul frame to the first access point. The second half of the backhaul frame sent from the second access point to the first access point contains data that is not part of the data inventoried by the second access point. Therefore, the headers always refer to data that will be sent in subsequent backhaul frames and not the backhaul frames carrying the information. In step 510, the first access point receives the second half of the backhaul frame from the second access point. In step 512, the first access point determines the percentage of the total data-carrying capacity of the next backhaul frame to use to send data to the second access point. The percentage of the next backhaul frame used to send the data from the first access point to the second access point is determined by multiplying the total data-carrying portion of the frame by the amount of data to be sent from the first access point to the second access point and dividing by the sum of the amount of data to be sent from the first access point to the second access point and the amount of data to be received from the second access point.

In step 514, the first access point determines how much data it will have left to send to the second access point in the next frame utilizing the percentage of the backhaul frame allocated in the previous step. In step 516, the first access point places an indicator in the header of the first half of a backhaul frame. The indicator comprises the determined amount of data that it has to send to the second access point after the current frame is sent. In step 516, the first access point also places data in the payload of the current frame, where the payload portion is adjusted according to the calculation made in step 512. In step 518, the second access point receives the first half of the backhaul frame including the payload data and indicator of remaining data.

After sending to the first access point data utilizing the remaining percentage of the current backhaul frame, the second access point determines in step 520 how much data it will have left to send to the first access point in the next frame. In step 522, the second access point places in the header of the second half of a backhaul frame an indicator of the determined amount of data it has to send to the first access point after the current frame is sent. The second access point also places data in the payload of the current frame, where the payload portion is the remainder of a single frame according to the calculation made in step 512. The flow then moves back to step 510, where the first access point receives the second half of the backhaul frame including the data and indicator of remaining data. The process then continues as described above.

It should be noted that an Access Point may have several neighboring access points in a mesh backhaul network. In such cases, the access point will be simultaneously performing the above mentioned processes (i.e. exchanging backhaul frame bandwidth needs with each neighbor, as well as transmitting and receiving information to/from each neighbor) with each neighboring access point on a backhaul frame-by-frame basis.

The foregoing embodiments of the present invention are advantageous because they provide dynamic optimization of the resources available to wireless communication devices. Information can be more efficiently communicated between subscriber devices and a core network by optimizing uplink and downlink time distribution within backhaul frames. The present invention, according to one embodiment, reduces unused frame portions and maximizes frame data-carrying capacity.

It should be noted that the Distributed Mesh Backhaul Bandwidth Assignment Method of the present invention will work with any technology (including Advanced Antenna schemes for Point to Point wireless communication). An embodiment of the present invention can also decouple the radio access technology from the advanced radio technologies suitable for backhaul communication and mesh network architectures.

### NON-LIMITING EXAMPLE

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, in a wireless communication system providing at least one time division duplexing communication channel for communicating data between a first and a second access point, the method comprising:
determining an amount of data to be sent from a first access point to a second access point;
receiving a value indicating an amount of data to be received from the second access point; and
determining a percentage of a frame to be used to send the data from the first access point to the second access point by multiplying the total data-carrying portion of the frame by the amount of data to be sent from the first access point to the second access point divided by the sum of the amount of data to be sent from the first access point to the second access point and the amount of data to be received from the second access point.

2. The method according to claim 1, further comprising:
determining a percentage of the frame to be used to receive the data from the second access point by multiplying the total data-carrying portion of the frame by the amount of data to be received from the second access point divided by the sum of the amount of data to be sent from the first access point to the second access point and the amount of data to be received from the second access point.

3. The method according to claim 2, further comprising:
sending to the second access point a value indicating the determined amount of data to be sent from the first access point to the second access point before receiving the value indicating the amount of data to be received from the second access point.

4. The method according to claim 3, wherein the frame is a backhaul frame.

5. The method according to claim 4, wherein:
the value sent to the second access point is sent from the first access point to the second access point as a portion of a frame that precedes the backhaul frame.

6. The method according to claim 5, wherein:
the value received from the second access point is a portion of the frame that precedes the backhaul frame.

7. A first access point in a wireless communication system providing at least one time division duplexing communication channel for communicating data between the first access point and a second access point, the first access point comprising:
a data counter for determining an amount of data to be sent to the second access point;
an input communicatively coupled to the data counter for receiving a value indicating an amount of data to be received from the second access point; and
a processor communicatively coupled to the input for determining a percentage of a frame to be used to send the data from the first access point to the second access point by multiplying the total data-carrying portion of the frame by the amount of data to be sent from the first access point to the second access point divided by the sum of the amount of data to be sent from the first access point to the second access point and the amount of data to be received from the second access point.

8. The first access point according to claim 7, wherein:
the processor determines a percentage of the frame to be used to received the data from the second access point by multiplying the total data-carrying portion of the frame by the amount of data to be received from the second access point divided by the sum of the amount of data to be sent from the first access point to the second access point and the amount of data to be received from the second access point.

9. The first access point according to claim 8, further comprising:
an output for sending to the second access point a value indicating the determined amount of data to be sent from the first access point to the second access point before receiving the value indicating the amount of data to be received from the second access point.

10. The first access point according to claim 9, wherein the frame is a backhaul frame.

11. The first access point according to claim 10, wherein:
the value sent to the second access point is sent from the first access point to the second access point as a portion of a frame that precedes the backhaul frame.

12. The first access point according to claim 11, wherein:
the value received from the second access point is a portion of the frame that precedes the backhaul frame.

13. A computer program product for distributing bandwidth in bilateral communication frames, the computer program product comprising:
a storage medium readable by a processing circuit and storing instructions for execution by the processing circuit for performing a method comprising:
determining an amount of data to be sent from a first access point to a second access point;
receiving a value indicating an amount of data to be received from the second access point; and
determining a percentage of a frame to be used to send the data from the first access point to the second access point by multiplying the total data-carrying portion of the frame by the amount of data to be sent from the first access point to the second access point divided by the sum of the amount of data to be sent from the first access point to the second access point and the amount of data to be received from the second access point.

14. The computer program product according to claim 13, further comprising:
determining a percentage of the frame to be used to received the data from the second access point by multiplying the total data-carrying portion of the frame by the amount of data to be received from the second access point divided by the sum of the amount of data to be sent from the first access point to the second access point and the amount of data to be received from the second access point.

15. The computer program product according to claim 14, further comprising:
sending to the second access point a value indicating the determined amount of data to be sent from the first access point to the second access point before receiving the value indicating the amount of data to be received from the second access point.

16. The computer program product according to claim 15, wherein the frame is a backhaul frame.

17. The computer program product according to claim 16, wherein:
the value sent to the second access point is sent from the first access point to the second access point as a portion of a frame that precedes the backhaul frame.

18. The computer program product according to claim 17, wherein:
the value received from the second access point is a portion of the frame that precedes the backhaul frame.
